(19) United States
(12) Patent Application Publication
(10) Pub. No.: US 2024/0257811 A1
(43) Pub. Date: Aug. 1, 2024

(54) System and Method for Providing Real-time Speech Recommendations During Verbal Communication

(71) Applicant: Nuance Communications, Inc., Burlington, MA (US)

(72) Inventors: Sharmistha Sarkar Gray, Dracut, MA (US); Uwe Helmut Jost, Groton, MA (US); Neeraj Deshmukh, Woburn, MA (US)

(21) Appl. No.: 18/297,066

(22) Filed: Apr. 7, 2023

Related U.S. Application Data
(60) Provisional application No. 63/442,183, filed on Jan. 31, 2023.

(51) Int. Cl. G10L 15/22; G06F 3/16; G10L 13/02; G10L 15/187; G10L 25/63; G10L 25/78

(52) U.S. Cl. CPC G10L 15/222; G06F 3/167; G10L 13/02; G10L 15/187; G10L 25/63; G10L 25/78; G10L 2015/228

(57) ABSTRACT

A method, computer program product, and computing system for processing, using a speech processing system, an input speech signal associated with a user. Context information for the input speech signal is determined from an external reference associated with the verbal communication using an artificial intelligence-based prediction system. The input speech signal is monitored for a predefined intervention pattern. In response to identifying the predefined intervention pattern in the input speech signal, one or more speech recommendations are generated for the user based upon, at least in part, the context using an artificial intelligence-based prediction system and the speech processing system.

### RELATED APPLICATION(S)

This application claims the benefit of U.S. Provisional Application No. 63/442,183 filed on 31 Jan. 2023, the entire contents of which is incorporated herein by reference.

### BACKGROUND

Many people struggle giving live presentations and, even after successfully practicing a presentation, the stress of a live presentation can lead to embarrassing moments of hesitation and the inability to remember or pronounce unfamiliar or particularly difficult words or phrases. This can prevent participants from engaging during meetings or even from volunteering for presentations. This can have career-limiting effects for people with speech impairments (e.g., stuttering) or other cognitive limitations. Additionally, individuals whose first language is not the language of a given meeting or presentation may be practically excluded from participation for fear of misspeaking due to their accent and/or pronunciation of particular terms or phrases.

For example, people tend to rely strongly on the impression they receive just from watching and listening to other people and it is well known that the quality of a presentation can have a greater impact on the overall impression of the presenter than the quality of the content presented. Consequently, people who struggle with presentations are often judged to be less competent than they really are, and their abilities are often underutilized. This can disproportionally limit people belonging to groups or classes who are already experiencing societal disadvantages. Conventional approaches to prompt users rely on limited text-based dialogues and do not account for real-time challenges during a presentation in which a participant is speaking.

### BRIEF DESCRIPTION OF THE DRAWINGS

FIG. 1 is a flow chart of one implementation of the speech prompting process;

FIGS. 2-6 are diagrammatic views of the speech prompting process in accordance with various implementations of the speech prompting process; and

FIG. 7 is a diagrammatic view of a computer system and the speech prompting process coupled to a distributed computing network.

Like reference symbols in the various drawings indicate like elements.

### DETAILED DESCRIPTION OF THE PREFERRED EMBODIMENTS

As will be discussed in greater detail below, implementations of the present disclosure use the combination of speech processing systems (e.g., real-time automated speech recognition (ASR)) and artificial intelligence (AI)-based prediction engines or systems to process a user's speech (e.g., during a presentation), determine context for user's speech (e.g., from presentation notes, from a question raised during a verbal communication, from a document displayed during a presentation, etc.), monitor for predefined intervention patterns or cues, and provide contextual speech recommendations or prompts for the user to select from in real-time during their verbal communication (e.g., a live presentation, a virtual presentation, a conference call, a telehealth appointment, a customer service call, etc.). For example, the output of automated speech recognition systems is coupled with natural language understanding (NLU) models and AI-based prediction engines to generate speech recommendations or prompts to help a user navigate a conversation, presentation, or other verbal communication event. In one example, a predefined intervention pattern (e.g., a predefined period of silence, at least a threshold amount of inarticulate utterances within a predefined period of time, at least a threshold stress level, and at least a threshold number of mispronounced words) is identified in the user's speech and one or more speech recommendations are provided to the user prompting the user on what to say next and/or how to say a particular word or phrase. In this manner, the combination of speech processing systems and AI-based prediction engines is able to quickly prompt a user during a moment of hesitation or guide the user away from words or terms that are difficult for that user to pronounce.

The details of one or more implementations are set forth in the accompanying drawings and the description below. Other features and advantages will become apparent from the description, the drawings, and the claims.

### The Speech Prompting Process:

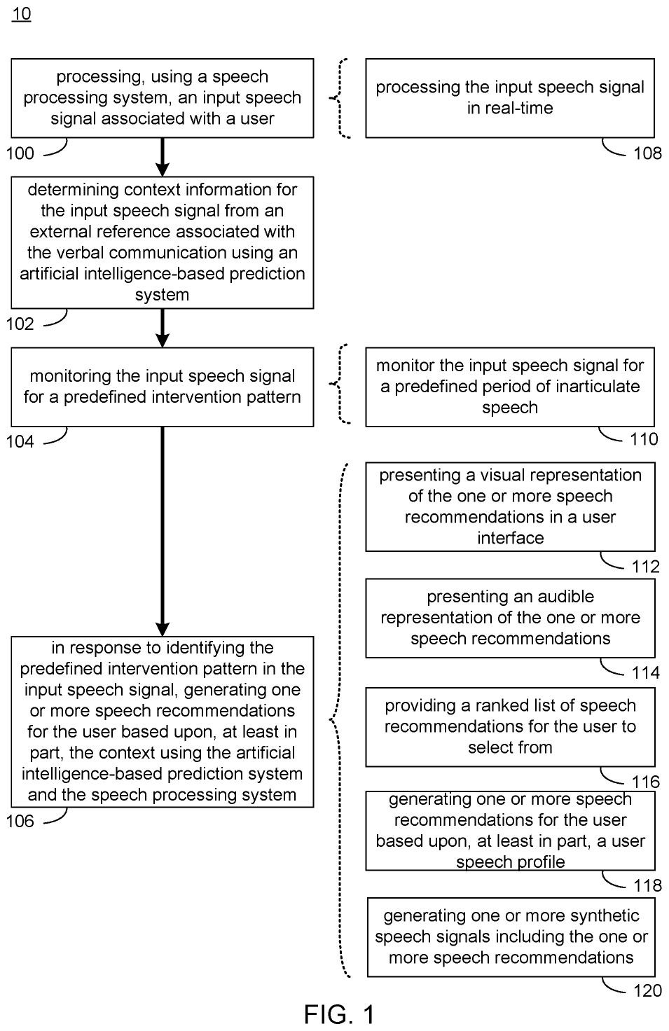

Referring to FIGS. 1-7, speech prompting process 10 processes 100, using a speech processing system, an input speech signal associated with a user. Context information for the input speech signal is determined 102 from an external reference associated with the verbal communication using an artificial intelligence-based prediction system. The input speech signal is monitored 104 for a predefined intervention pattern. In response to identifying the predefined intervention pattern in the input speech signal, one or more speech recommendations are generated 104 for the user based upon, at least in part, the context using an artificial intelligence-based prediction system and the speech processing system.

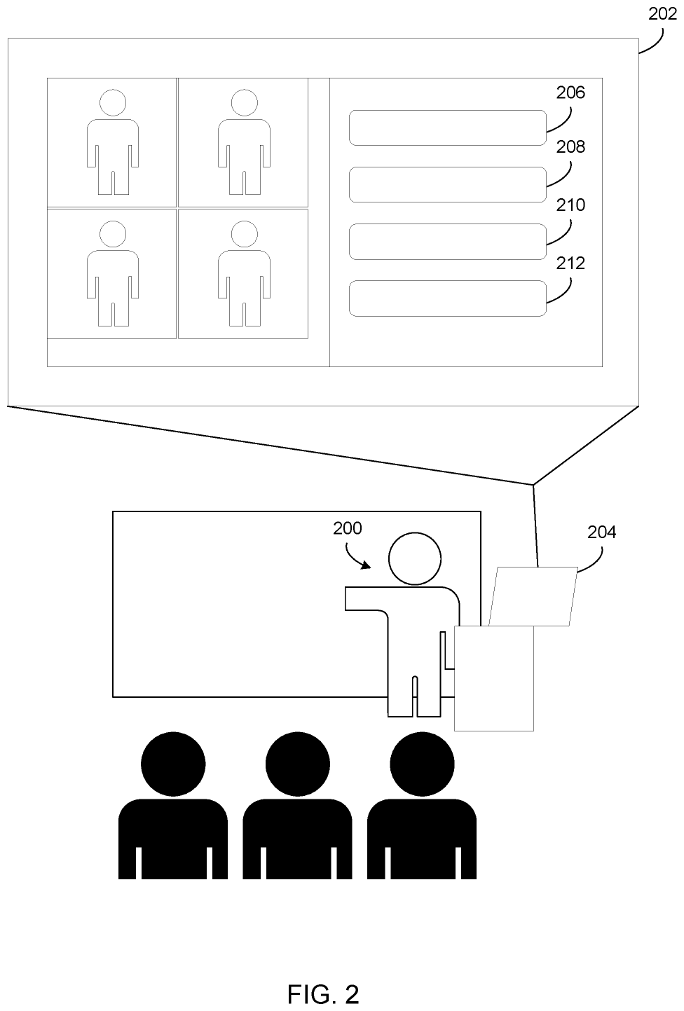

As discussed above, implementations of the present disclosure allow for the detection of particular intervention patterns or cues during a verbal communication and generation of contextual prompts or recommendations to assist the user with their participation in the verbal communication. Referring also to FIG. 2, suppose a user (e.g., user 200) is participating in a presentation. In this example, user 200 is standing in front of a group of participants in-person and electronically (as shown by the view of the user interface 202 of computing device 204 visible to user 200 with multiple remote participants). While presenting, user 200 may struggle with a particular phrase, may become nervous, and/or may not understand a question raised by a participant. Accordingly, speech prompting process 10 is able to monitor for these situations and generate speech recommendations or prompts (e.g., speech recommendations 206, 208, 210, 212) to guide user 200 through their particular issue or through the presentation generally. Specifically and as will be described in greater detail below, speech prompting process 10 may involve speech processing systems, AI-based prediction engines, and/or synthesized speech to either provide recommendations for specific content for user 200 to speak or to synthesize user 200's voice and speak on user's behalf.

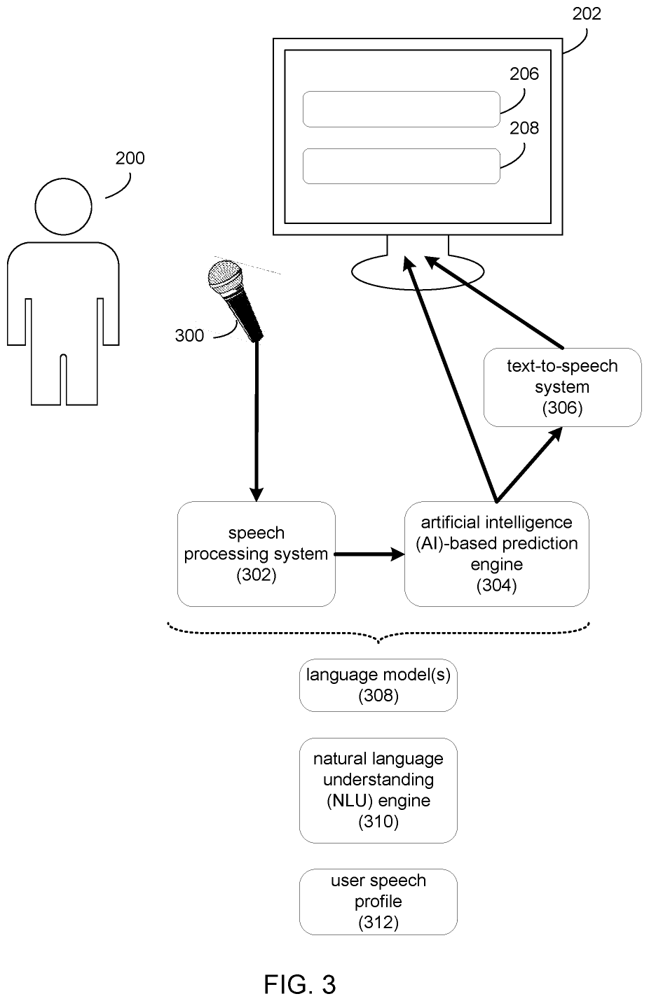

In some implementations, speech prompting process 10 processes 100, using a speech processing system, an input speech signal associated with a user. Referring also to FIG. 3 and in some implementations, speech prompting process 10 includes an audio recording device (e.g., audio recording device 300), a speech processing system (e.g., speech processing system 302), an artificial intelligence (AI)-based prediction engine (e.g., AI-based prediction engine 304), and/or a text-to-speech system (e.g., text-to-speech system 306).

A speech processing system is a software component with one or more algorithms that process an input speech signal and generate representations of the speech. In one example, speech processing system 302 includes an automatic speech recognition (ASR) system that converts an input speech signal into a textual representation and/or another machine-readable format. In some implementations, speech processing system 302 is a low latency ASR system that produces textual representations or other machine-readable representations within a predefined threshold of time. For example, as speech prompting process 10 monitors for and identifies particular intervention patterns in the user's speech, the more quickly that speech prompting process 10 can process 100 the input speech signal and provide speech recommendations, the more helpful the recommendations will be to the user. Accordingly, speech prompting process 10 may use a speech processing system with a predefined latency limit to provide recommendations as quickly as possible.

In some implementations, speech prompting process 10 determines 102 context information for the input speech signal from an external reference associated with the verbal communication using an artificial intelligence-based prediction system. Determining context information generally includes processing available information associated with a verbal communication (e.g., previous dialogue, external references, information about the location of the verbal communication, information about the nature of the verbal communication, etc.) to determine what topics, concepts, words, or phrases are likely or not likely to be included during the verbal communication. An external reference associated with a verbal communication includes a document or other resource that informs an AI-based prediction engine (e.g., AI-based prediction engine 304) with context information for the verbal communication. For example, suppose that a user is giving a presentation and is referencing a copy of the presentation displayed in a user interface. In this example, the presentation is an external reference that informs an AI-based prediction engine with what a user is likely to say next during the presentation.

In one example, as a user navigates portions or pages of the presentation, AI-based prediction engine 304 ingests the speech signal and the content of the current portion or page to determine what the user is currently saying and what the user may say next. In this example, the external reference is the presentation or presentation material available to the user during a verbal communication. In another example, the external reference includes an electronic health record from which a medical professional reads when interviewing a patient. In another example, the external reference includes a service guide for resolving certain issues that is used by a customer service agent. In another example, the external reference includes a generative AI model (e.g., ChatGPT) that processes the input speech signal in real-time to determine what the user may say next given their previous utterance(s) or other information from the verbal communication that is provided to the generative AI model.

An artificial intelligence (AI)-based prediction engine (e.g., AI-based prediction engine 304) is software component that predicts, suggests, discovers, and adapts its outputs according to its training. Specifically, AI-based prediction engine 304 generates predictions based on using models to analyze the relationship between defined variables. This can be a relationship focusing on a performance, attributes or features. The model estimates the likelihood of the relationship in comparison to a sample that has been designated earlier. Accordingly, with the input textual speech and some contextual information (e.g., copy of presentation, customer service script, telehealth patient information, etc.), AI-based prediction engine 304 predicts what the user may or should say next based on what is being said in real-time and the context of what else needs to be shared from a presentation, or read from a customer service script, etc.

In some implementations, AI-based prediction engine receives the textual representations generated by speech processing system 302 as user 200 is speaking, in response to identifying a predefined intervention pattern, and/or periodically. In one example, AI-based prediction engine 304 uses one or more language models (e.g., language model(s) 308), natural language understanding (NLU) engine 310, and/or a user speech profile (e.g., user speech profile 312) to predict what the user should or could say next given their current context. In another example, AI-based prediction engine 304 uses an external reference (e.g., a copy of a presentation, script, or other information) associated with user 200′s verbal communication (e.g., presentation, telehealth appointment, customer service script, etc.). With this context information, AI-based prediction engine 304 is able to generate predictions on topics or concepts that the user is likely going to address or may want to address next.

In another example, AI-based prediction engine 304 uses language model 308 to predict what user 200 is most likely going to say next or what user 200 should say next. For example, this can be based on general language models (e.g., large foundation language models) but also on domain-specific language models, or a practice presentation the speaker prepared. In some implementations, AI-based prediction engine 304 provides a prediction of the continuation of the current word or phrase of the input speech signal, given: the context of the verbal communication (so far), more general domain information, similar verbal interactions (e.g., presentations, meetings, telehealth appointments, etc.), and/or other utterances by the same speaker (e.g., utterances from practice presentations).

In some implementations, processing 100 the input speech signal includes processing 108 the input speech signal in real-time. Real-time generally includes instantaneous processing from the moment in time the input speech signal is received by audio recording device 300 and processed by speech processing system 302. In this manner, the input speech signal is processed as it is received and processed by speech processing system 302. In one example, speech processing system 302 generates textual representations of each input speech signal and AI-based prediction engine 304 processes each textual representation to determine the current context of the user's speech. In this manner, the combination of speech processing system 302 and AI-based prediction engine 304 monitor user 200's speech to understand the current context in real-time.

In some implementations, speech prompting process 10 monitors 104 the input speech signal for a predefined intervention pattern. A predefined intervention pattern is an observable condition or pattern in the input speech signal indicative of user issues with speaking. In one example, the predefined intervention pattern includes a predefined period of silence. For example, suppose user 200 is giving a presentation to remote participants of a conference call using a collaboration tool (e.g., Microsoft® Teams®). In this example, suppose that user 200 is presenting on a particular topic when user 200 suddenly loses their focus and searches their presentation notes in silence for at least a threshold number of seconds. Accordingly, speech prompting process 10 identifies this period of silence as a predefined intervention pattern triggering the generation of speech recommendations for user 200 to say. In this example, the predefined period of silence is default value (e.g., two seconds, four seconds, etc.). In another example, the period of silence is unique to user 200 and is determined by speech prompting process 10 based upon user 200's speech rate over a particular period of time. In this manner, the predefined period of silence is updated to reflect the context of the verbal communication and the user's cadence.

In some implementations, monitoring 104 the input speech signal for a predefined intervention pattern includes monitoring 110 the input speech signal for a predefined period of inarticulate speech. For example, the predefined intervention pattern includes at least a threshold amount of inarticulate utterances within a predefined period of time or a period of inarticulate speech. Inarticulate speech is a non-silent utterance that includes speech characteristics or phonemes that do not define complete words or phrases. Examples of inarticulate speech include individual phonemes, combinations of phonemes that do not define coherent words or phrases, and filler words (e.g., “um”, “well”, “hmmm”, etc.). In some implementations, speech prompting process 10 accesses a database or other resource with examples of inarticulate utterances to compare against utterances of the input speech signal. For example and referring again to FIG. 2, suppose user 200 is giving a presentation to in-person and remote participants. In this example, user 200 may have difficulty speaking in large meetings. In particular, user 200's limitations may be manifest as periods of inarticulate filler words (e.g., “um”, “well”, “hmmm”, etc.).

In another example, the predefined intervention pattern includes at least a threshold stress level. For example, suppose user 200 is giving a presentation while experiencing increasingly elevated levels of stress. In some implementations, audio recording device 300 detects stress levels or changes in volume indicative of fear or stress in the input speech signal. For example, suppose user 200's voice softens during a portion of the presentation. In this example, the softening of the voice may pass a predefined volume threshold indicative of an intervention pattern. In another example, suppose that the stress level rises above a predefined stress threshold. In this example, the increase in stress level indicates an intervention pattern. In a variation of this example, the threshold level of stress is observed for a least a threshold amount of time or includes a threshold change in stress level over a predefined period of time. Accordingly, speech prompting process 10 identifies a predefined intervention pattern in the input speech signal and, as will be discussed in greater detail below, provides speech recommendations for the user to say to reduce the stress level. In this example, by providing examples of words or phrases to say next given the context information for the verbal communication, a user's stress levels will decrease (e.g., below the threshold).

In another example, the predefined intervention pattern includes at least a threshold number of mispronounced words. For example, suppose user 200 is a medical professional meeting with a patient using a telehealth application. In this example, suppose that user 200 has difficulty pronouncing various medical terms. During the verbal communication with a patient, suppose user 200 is enquiring about the patient's prescription history and is struggling to pronounce the names of various prescriptions. Accordingly, speech prompting process 10 monitors 104 and identifies a predefined intervention pattern in at least a threshold number of mispronunciations of the prescription names. In one example, the predefined threshold of mispronunciations is a predefined number of mispronunciations in a predefined period of time (e.g., three mispronunciations in five seconds). In another example, the predefined number of mispronunciations is a predefined number of mispronunciations for a particular word or phrase. For example, suppose user 200 is reviewing an electronic health record with a patient and is confirming the patient's medical history. Suppose that while reviewing one prescription name (i.e., “OnabotulinumtoxinA”, a treatment for chronic migraines), user 200 struggles to pronounce the prescription name. In this example, speech prompting process 10 monitors 104 the input speech signal to count the number of attempts user 200 makes to pronounce “OnabotulinumtoxinA”. In response to monitoring 104 at least a threshold number of pronunciations (e.g., three mispronunciations in five seconds), speech prompting process 10 identifies a predefined intervention pattern and, as will be discussed below, generates speech recommendations (e.g., speech recommendations to help user 200 pronounce the mispronounced prescription name).

In another example, the predefined intervention pattern includes a predefined phrase (e.g., “I lost my train of thought”, “I forgot what I was going to say”, “I lost my place”, etc.). The predefined phrase may be user-defined, a default phrase, or a phrase “learned” by the AI-based prediction system as being associated with other predefined intervention patterns (e.g., “Um, I lost my train of thought”, “Hold on one second, I lost my place . . . Hmmm”, etc.). In this manner, a user may define their own predefined intervention patterns or access a library or database of existing intervention patterns. As will be discussed in greater detail below, in response to identifying a predefined intervention pattern, speech prompting process 10 can generate and provide speech recommendations for the user.

In some implementations and in response to identifying the predefined intervention pattern in the input speech signal, speech prompting process 10 generates 106 one or more speech recommendations for the user using an artificial intelligence-based prediction system and the speech processing system. A speech recommendation is a sample phrase or word provided to the user for the user to speak. Returning to the above example, suppose that user 200 begins to say inarticulate utterances repeatedly (e.g., “um”). In response to identifying the predefined intervention pattern (i.e., a threshold number of inarticulate utterances in user 200's speech), speech prompting process 10 generates one or more speech recommendations (e.g., speech recommendations 206, 208, 210, 212). In some implementations, the one or more speech recommendations (e.g., speech recommendations 206, 208, 210, 212) are provided privately to user 200 such that only user 200 has access to the speech recommendations. As will be discussed in greater detail below, speech prompting process 10 generates speech recommendations that are best suited to the conversational situation, speaker proficiency, stress level, etc. for the user for their particular verbal communication (e.g., presentation, conference call, telehealth appointment, etc.).

In some implementations, generating 106 the one or more speech recommendations for the user includes one or more of: presenting 108 a visual representation of the one or more speech recommendations in a user interface; and presenting 112 an audible representation of the one or more speech recommendations. For example and as shown in FIGS. 2-3, suppose user 200 is giving a presentation and has access to a computing device (e.g., computing device 204) with a user interface (e.g., user interface 202). In this example, speech prompting process 10 generates 106 one or more speech recommendations (e.g., speech recommendations 206, 208, 210, 212) and presents 108 a visual representation of the speech recommendations on a user interface (e.g., user interface 202). As discussed above, the visual representation of speech recommendations 206, 208, 210, 212 is a word or phrase for the speaker to say in response to the predefined intervention pattern (e.g., inarticulate utterances). In some implementations, speech prompting process 10 presents 108 the visual representations of speech recommendations to other displays associated with a user (e.g., a mobile device, a smart glass display, a teleprompter, pop-up window in a presentation, etc.).

In another example, speech prompting process 10 presents an audible representation of the one or more speech recommendations to an audio device associated with the user. For example, suppose user 200 is wearing headphones or an earpiece during the presentation. In this example, speech prompting process 10 presents 112 an audible representation of a highest ranked (as will be discussed below) speech recommendation to the user. Accordingly, speech prompting process 10 presents the generated speech recommendations in various formats particular to accessibility by the speaker. In this manner, the user is able to receive the speech recommendations to select from in a private manner (e.g., shown or played only to the user).

In some implementations, generating 106 the one or more speech recommendations for the user includes providing 114 a ranked list of speech recommendations for the user to select from. For example, AI-based prediction engine 304 may generate a list of multiple speech recommendations. In one example, AI-based prediction engine 304 generates a list of possible speech recommendations based on what the user may say next given the context information of the last words spoken, an external reference (e.g., a presentation with context information indicating that the user just spoke about slide 23 so the next topic is likely on slide 24), or from other sources. As there are different probabilities that user 200 will say any particular speech recommendation, speech prompting process 10 provides a ranked list of speech recommendations based on these probabilities. As shown in FIG. 3, suppose speech prompting process 10 generates speech recommendations 206, 208, 210, 212. In this example, speech recommendation 206 is the most likely content (e.g., word(s) or phrase) that user 200 will say next or should say next in the given context while speech recommendation is the relatively least likely word(s) or phrase that user 200 will say next compared to other speech recommendations. In this manner, the ranked listing of speech recommendations is presented to user 200 for selection.

In some implementations, when the speaker starts a word, speech prompting process 10 updates the prediction (e.g., one or more speech recommendations) to match the spoken word and looks for synonyms that might be easier to say for the speaker thereby avoiding sounds that are likely to trigger stuttering, to create an updated ranked prediction list. The alternatives might be a combination of words with different meanings and synonyms of these words. In this manner, speech prompting process 10 provides a ranked list of speech recommendations that are chosen to emphasize terms or words that the speaker can pronounce clearly. For example, suppose user 200 has a stutter in their speech. In this example, speech prompting process 10 generates 106 one or more speech recommendations with words or phrases chosen by AI-based prediction engine 304 to avoid particular words or phonemes that may induce or emphasize stuttering by user 200. In this manner, the ranked listing may be influenced by various word or pronunciation characteristics.

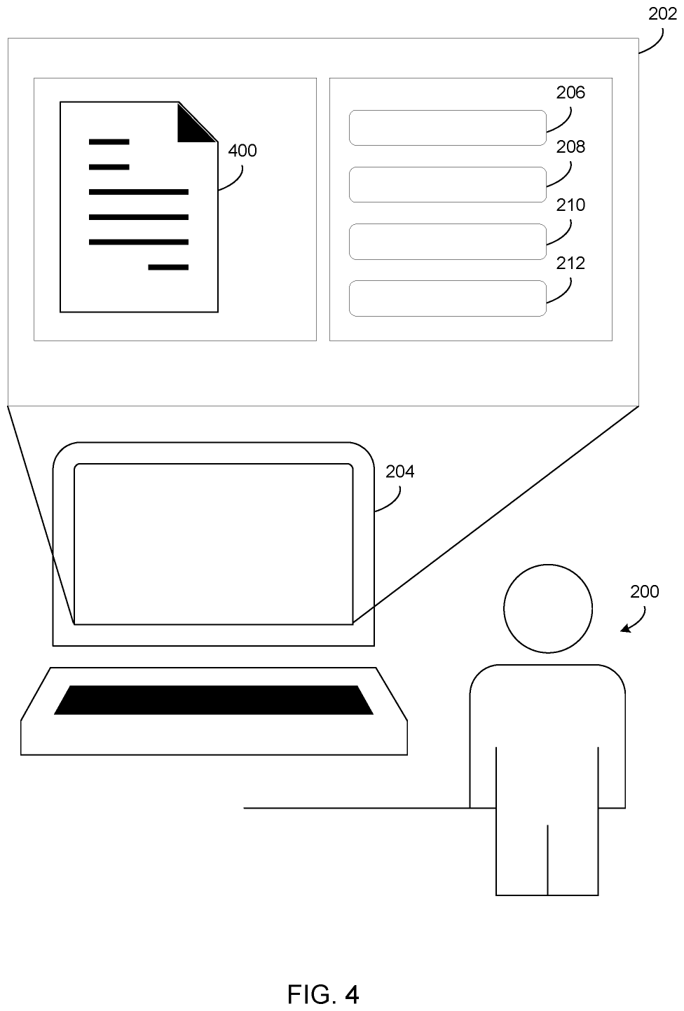

Referring also to FIG. 4, suppose user 200 is a customer service agent assisting a customer over the phone with a particular concern. In this example, user 200 is using computing device 204 to communicate with a customer. Computing device 204 includes an audio recording device that processes input speech signals from user 200. In some implementations, suppose user 200 has a particular script or customer service guide available (e.g., script 400). In this example, suppose that while assisting a customer, user 200 is confused by a question from the customer and pauses for a long time. In response to identifying a predefined intervention pattern (e.g., user 200's long pause), speech prompting process 10 generates 106 one or more speech recommendations (e.g., speech recommendations 206, 208, 210, 212) using previous dialogue between user 200 and the customer, and script 400 for context. Accordingly, speech prompting process 10 provides speech recommendations 206, 208, 210, 212 for user 200 to select from (i.e., to say) to address the identified predefined intervention pattern. Specifically, speech prompting process 10 provides speech recommendations 206, 208, 210, 212 consistent with script 400.

In some implementations, generating 401 the one or more speech recommendations for the user includes generating 116 one or more speech recommendations for the user based upon, at least in part, a user speech profile. For example, a user speech profile (e.g., user speech profile 312) is a description of a user's speech characteristics in terms or difficult words for the user to pronounce that should be avoided, information concerning a user's speech capabilities (i.e., history of speech impediment), primary language spoken, preferred language to speak in, or any other information that demonstrates a user's speaking abilities or preferences. Accordingly, speech prompting process 10 has the language proficiency of the speaker and any speech impediment the speaker might have with this user speech profile (e.g., user speech profile 312). In some implementations, user speech profile is user-defined or defined automatically over time through observation. For example, the more the speaker uses the speech recommendations, the more that speech prompting process 10 (specifically through the training of AI-based prediction system 304) will keep learning which sounds are difficult for the user to pronounce and improve itself to provide better choices of speech recommendations in the future. In some implementations, user speech profile 312 includes a database of words and how familiar a speaker with the estimated proficiency would be expected to be with these words (e.g., based on information about learning a second language or specific speech impediments). In some implementations, speech prompting process 10 generates speech recommendations from predictions of AI-based prediction engine 304 that the speaker is most likely to be able to say. Additionally, speech prompting process 10 uses user speech profile to generate create content that is consistent with the normal behavior of the speaker (i.e., normal phrases, terminology, or emphasis while speaking).

In some implementations, generating 116 one or more speech recommendations for the user based upon, at least in part, a user speech profile includes providing speech recommendations from a previous recording associated with a user. For example, suppose user 200 records the presentation previously (e.g., during a practice presentation or an earlier presentation). In this example, speech prompting process 10 generates speech recommendations by providing portions of a speech signal from the previous recording corresponding to the speech recommendations. For instance, suppose that user 200 has difficulty saying the name of an author of an article user 200 is discussing. However, suppose that during a previous recording of the presentation, user 200 correctly pronounced the name of the author. Accordingly, speech prompting process 10 determines 102 context information from the previous recording and monitors 104 for the predefined intervention pattern (i.e., user 200 struggling or history of user 200 struggling to pronounce the author's name). Speech prompting process 10 processes the previous recording to identify a speech portion corresponding to the author's name and provides a selection for a speech recommendation that, when selected, causes the previous recording of the author's name to be played back in the presentation. In some implementations, previous recordings are stored in and/or referenced within the user speech profile.

In some implementations, generating 106 the one or more speech recommendations for the user includes generating 118 one or more synthetic speech signals including the one or more speech recommendations. A synthetic speech signal is a generated speech signal that is designed to replicate the speaker's voice. In one example, the synthetic speech signal is generated using a text-to-speech (TTS) system (e.g., text-to-speech system 306). In some implementations, speech prompting process 10 supports the speaker by generating speech recommendations that can be played back to temporarily “replace” the speaker. In this manner, speech prompting process 10 not only generates 106 speech recommendations that are likely to be easy to say for the specific speaker but also generates 118 speech recommendations that are the most appropriate in the conversational context and are available from existing recordings or otherwise easy to produce in good quality. In some implementations and as shown in FIG. 3, TTS system 306 receives the one or more speech recommendations from AI-based prediction system 304. In one example, TTS system 306 uses portions or snippets of previous audio (or audiovisual) utterances by the speaker or converted from other speakers to sound (and look) very similar to the current one. In another example, a speaker-personalized TTS system and/or speech animated video generated for the speaker are used to generate synthetic speech recommendations on demand.

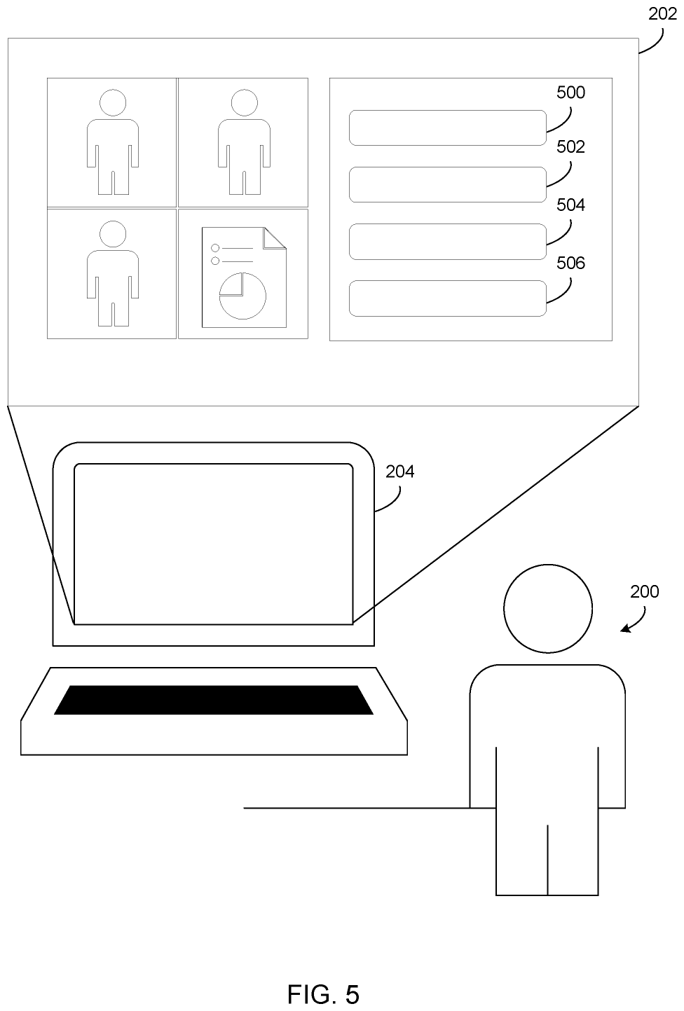

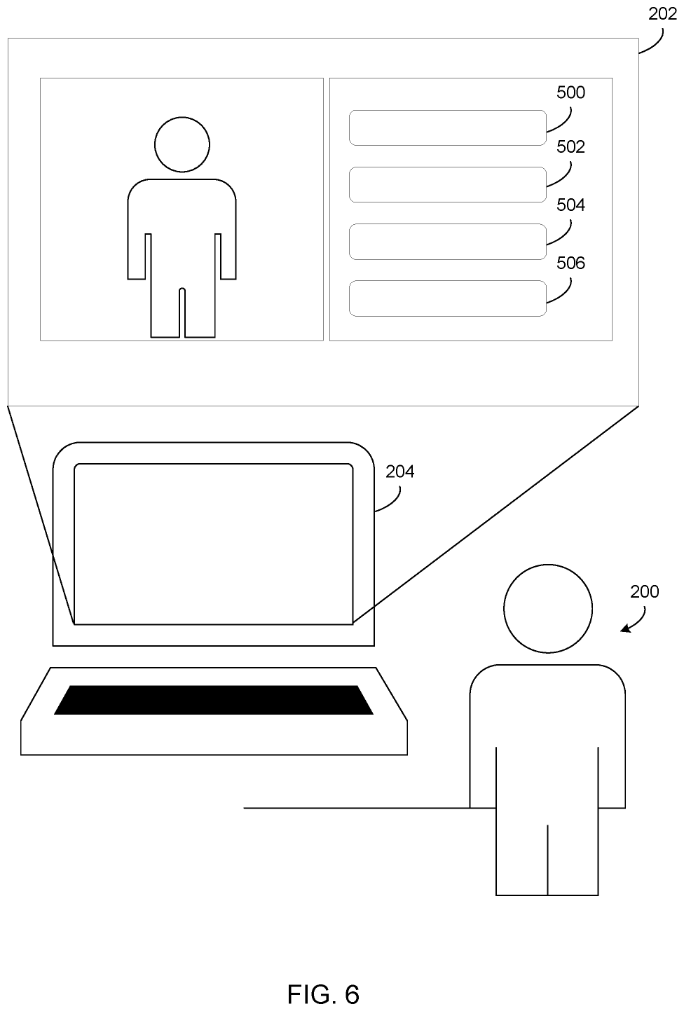

Referring also to FIG. 5, suppose user 200 is participating in a conference call using a collaboration tool (e.g., Microsoft® Teams®). In this example, user 200's speech signals are processed by an audio recording device of computing device 204 and video content is processed by a video recording device of computing device 204. Similarly, in FIG. 6, suppose user 200 is a medical professional participating in a telehealth appointment with a patient. In this example, user 200′s speech signals are processed by an audio recording device of computing device 204 and video content is processed by a video recording device of computing device 204. In each of these examples, speech prompting process 10 processes input speech signals from user 200, monitors 104 for predefined intervention patterns, and, in response to identifying a predefined intervention pattern, generates one or more speech recommendations (e.g., speech recommendations 206, 208, 210, 212).

In the example of FIG. 5, suppose user 200 is giving a presentation but continuously mispronounces a particular term. In this example, speech recommendations 206, 208, 210, 212 are presented in a user interface (e.g., user interface 202) within or separate from the collaboration tool. In some implementations, speech prompting process 10 generates one or more synthetic speech recommendations that provide synthetic speech signals on the user's behalf. For example, suppose user 200 selects synthetic speech recommendation 208. In this example, speech prompting process 10 provides the synthetic speech recommendation to other participants as if spoken by user 200 using TTS system 306. In some implementations, speech prompting process 10 generates a visual representation of user 200 speaking synthetic speech recommendation 208. In this manner, it appears and sounds as if user 200 spoke the words or terms of synthetic speech recommendation 208.

Referring also to FIG. 6, suppose user 200 is a medical professional conversing with a patient during a telehealth appointment. In this example, suppose that user 200 is in the process of describing a new medication that is available for the patient and that these medication names are new to user 200 and difficult to pronounce (e.g., “OnabotulinumtoxinA”). Accordingly, speech prompting process 10 monitors 104 the predefined intervention pattern from user 200 mispronouncing the prescription name and/or from context information describing the prescription and generates 118 one or more synthetic speech recommendations (e.g., synthetic speech recommendations 500, 502, 504, 506) for user 200 to select from. In this example, suppose that user 200 selects synthetic speech recommendation 500. Speech prompting process 10 provides the synthetic speech recommendation to the patient including the medication names as if spoken by user 200 using TTS system 306. Similarly, speech prompting process 10 can generate a visual representation of user 200 speaking synthetic speech recommendation 600. In this manner, it appears and sounds to the patient as if user 200 spoke the words or terms of synthetic speech recommendation 500.

In some implementations, suppose the medical professional (e.g., user 200) is filling out a prescription and/or a medical record with medication names and/or medical form codes. In this example, as the medical professional (e.g., user 200) is providing input speech signals, speech prompting process 10 main addition to identifying a predefined intervention pattern in the unique medication name, provide speech recommendations to guide the medical professional through the prescription filling process and/or medical record populating process. For example, suppose user 200 states “Medication B” and speech prompting process 10 processes 100 the input speech signal and AI-based prediction engine 304 identifies “Medication B”. In this example, speech prompting process 10 may provide various speech recommendations (e.g., speech recommendations 206, 208, 210, 212) in user interface 202 to help guide user 200 to say the names of the most likely medication for the prescription and/or the medical record. While this example concerns a particular medication name, it will be appreciated that this extends non-medical terminology where a user is filling in a form using speech processing technology and experiences a predefined intervention pattern (e.g., goes silent, begins to mumble or utter other inarticulate speech, etc.).

In some implementations, speech prompting process 10 generates one or more synthetic speech recommendations but presents them in response to identifying the predefined intervention pattern. However, in one example, speech prompting process 10 allows a user to request a continuation (i.e., word or phrase generation) even when synthetic speech recommendations are not presented. For example, this can occur when the speaker is desperate enough to trust the synthetic speech recommendation(s) to speak on their behalf and is prepared to “self” correct if needed. In some implementations, the one or more synthetic speech recommendations include playback of a specific pre-recorded utterance (e.g., a joke the speaker likes to tell, a particular greeting, a phrase to end a presentation or a meeting, etc.) as a synthetic speech recommendation. In this example, speech prompting process 10 provides one or more synthetic speech recommendations in a particular portion of a user interface that are always available for selection.

In some implementations, speech prompting process 10 recognizes a word spoken in the primary language of the speaker and translates the word into the target language for playback as a synthetic speech recommendation. In this manner, speech prompting process 10 can translate input speech signals that are not in the presentation or meeting language without disrupting the presentation or meeting.

In some implementations, when a user selects a synthetic speech recommendation, speech prompting process 10 provides a note or other disclaimer to participants indicating that a synthetic representation of the user is speaking. For example, suppose user 200 selects synthetic speech recommendation 500 during the conference call shown in FIG. 5. In this example, speech prompting process 10 provides a note or signal indicating that the participants are hearing synthetic speech on user 200's behalf. In some implementations, the note or disclaimer is provided in a transcription of the verbal communication.

In some implementations, generating 106 the one or more synthetic speech recommendations for the user includes defining one or more conditions for automatically providing a synthetic speech recommendation for the user. For example, speech prompting process 10 enables a user to formulate or define conditions under which speech recommendations are automatically provided (e.g., used in place of the speaker) during a verbal communication. In one example, a user selects (e.g., using a user interface) one or more conditions for automatically providing a synthetic speech recommendation. In this example, a condition for automatically providing a synthetic speech recommendation includes a timeout per level of word difficulty. In another example, a condition for automatically providing a synthetic speech recommendation includes identifying at least a threshold number of previous selections of the synthetic speech recommendation. In another example, a condition for automatically providing a synthetic speech recommendation includes identifying a set of predefined intervention patterns from the context information. For example, suppose that a user is reading a list of names of individuals and that speech prompting process 10 determines 104 context information from the list of individuals and predicts that user 200 will have difficulty when reading these names out loud. Accordingly, speech prompting process 10 proactively alerts user 200 (e.g., using a user interface) that speech prompting process 10 will automatically provide synthetic speech signals including each of the names of the list. In this example, user 200 can approve or reject this option (e.g., by selecting corresponding options in the user interface).

In some implementations, speech prompting process 10 generates a time window for generating the one or more synthetic speech recommendations by delaying transmission of the input speech signal by a predefined amount of time. For example, suppose user 200 is participating in a conference call using a collaboration tool (e.g., Microsoft® Teams®) as shown in FIG. 5. In this example, speech prompting process 10 increases the amount of time for generating speech recommendations generally and specifically synthetic speech recommendations, and for receiving a selection of a particular speech recommendation by delaying transmission of the input speech signal by a predefined amount of time. The predefined amount of time is user-defined, a default value, or automatically determined based on the transmission characteristics of the verbal communication.

In one example, the predefined amount of time is defined by the duration of the input speech signal and the number of speech recommendations generated for the user. In this manner, speech prompting process 10 delays transmission of the input speech signal to the participants by an amount of time dependent on the context to create a time window for interaction with the speaker and processing. Suppose user 200 is speaking and speech prompting process 10 identifies a predefined intervention pattern. In this example, speech prompting process 10 delays the transmission of the input speech signal until the speech recommendations are generated, presented to the user, and a speech recommendation is selected, or all speech recommendations are rejected. In this manner, the delay introduced from selecting a speech recommendation is not as noticeable by the participants of the meeting.

In some implementations, speech prompting process 10 dynamically adjusts playback of the input speech signal and a synthetic speech recommendation selected by the user based upon, at least in part, the time window for generating the one or more synthetic speech recommendations. For example, speech prompting process 10 dynamically speeds up and/or slows down audio (and visual) playback to smooth out gaps caused by presenter hesitation or speech recommendation processing times. As discussed above, suppose speech prompting process 10 delays transmission of the input speech signal in order to provide a time window for speech prompting process 10 to generate speech recommendations and for user 200 to select a speech recommendation. In this example, speech prompting process 10 dynamically adjusts the playback of the input speech signal and the selected speech recommendation and/or synthetic speech recommendation. For example, speech prompting process 10 may increase the playback speed for the input speech signal and selected synthetic speech recommendation to soften the time window introduced by speech prompting process 10. In this manner, speech prompting process 10 reduces the noticeable impact of the speech recommendations on the participants of the verbal communication.

### System Overview:

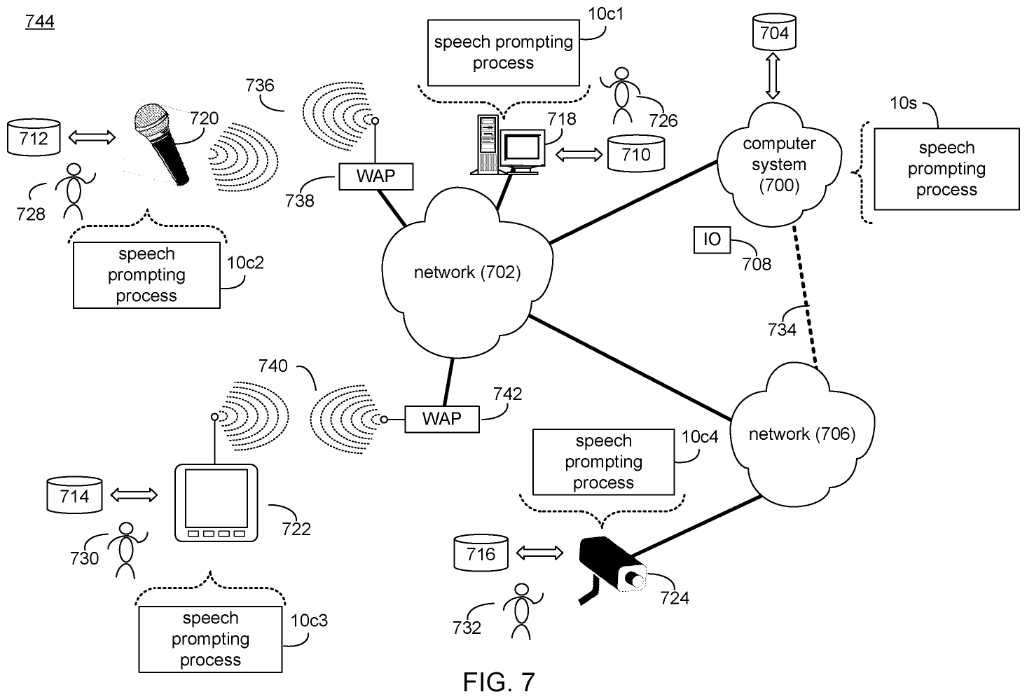

Referring to FIG. 7, there is shown speech prompting process 10. Speech prompting process 10 may be implemented as a server-side process, a client-side process, or a hybrid server-side/client-side process. For example, speech prompting process 10 may be implemented as a purely server-side process via speech prompting process 10s. Alternatively, speech prompting process 10 may be implemented as a purely client-side process via one or more of speech prompting process 10c1, speech prompting process 10c2, speech prompting process 10c3, and speech prompting process 10c4. Alternatively still, speech prompting process 10 may be implemented as a hybrid server-side/client-side process via speech prompting process 10s in combination with one or more of speech prompting process 10c1, speech prompting process 10c2, speech prompting process 10c3, and speech prompting process 10c4.

Accordingly, speech prompting process 10 as used in this disclosure may include any combination of speech prompting process 10s, speech prompting process 10c1, speech prompting process 10c2, speech prompting process 10c3, and speech prompting process 10c4.

Speech prompting process 10s may be a server application and may reside on and may be executed by a computer system 700, which may be connected to network 702 (e.g., the Internet or a local area network). Computer system 700 may include various components, examples of which may include but are not limited to: a personal computer, a server computer, a series of server computers, a mini computer, a mainframe computer, one or more Network Attached Storage (NAS) systems, one or more Storage Area Network (SAN) systems, one or more Platform as a Service (PaaS) systems, one or more Infrastructure as a Service (IaaS) systems, one or more Software as a Service (SaaS) systems, a cloud-based computational system, and a cloud-based storage platform.

A SAN includes one or more of a personal computer, a server computer, a series of server computers, a mini computer, a mainframe computer, a RAID device and a NAS system. The various components of computer system 700 may execute one or more operating systems.

The instruction sets and subroutines of speech prompting process 10s, which may be stored on storage device 704 coupled to computer system 700, may be executed by one or more processors (not shown) and one or more memory architectures (not shown) included within computer system 700. Examples of storage device 704 may include but are not limited to: a hard disk drive; a RAID device; a random access memory (RAM); a read-only memory (ROM); and all forms of flash memory storage devices.

Network 702 may be connected to one or more secondary networks (e.g., network 704), examples of which may include but are not limited to: a local area network; a wide area network; or an intranet, for example.

Various IO requests (e.g., IO request 708) may be sent from speech prompting process 10s, speech prompting process 10c1, speech prompting process 10c2, speech prompting process 10c3 and/or speech prompting process 10c4 to computer system 700. Examples of IO request 708 may include but are not limited to data write requests (i.e., a request that content be written to computer system 700) and data read requests (i.e., a request that content be read from computer system 700).

The instruction sets and subroutines of speech prompting process 10c1, speech prompting process 10c2, speech prompting process 10c3 and/or speech prompting process 10c4, which may be stored on storage devices 710, 712, 714, 716 (respectively) coupled to client electronic devices 718, 720, 722, 724 (respectively), may be executed by one or more processors (not shown) and one or more memory architectures (not shown) incorporated into client electronic devices 718, 720, 722, 724 (respectively). Storage devices 710, 712, 714, 716 may include but are not limited to: hard disk drives; optical drives; RAID devices; random access memories (RAM); read-only memories (ROM), and all forms of flash memory storage devices. Examples of client electronic devices 718, 720, 722, 724 may include, but are not limited to, personal computing device 718 (e.g., a smart phone, a personal digital assistant, a laptop computer, a notebook computer, and a desktop computer), audio input device 720 (e.g., a handheld microphone, a lapel microphone, an embedded microphone (such as those embedded within eyeglasses, smart phones, tablet computers and/or watches) and an audio recording device), display device 722 (e.g., a tablet computer, a computer monitor, and a smart television), machine vision input device 724 (e.g., an RGB imaging system, an infrared imaging system, an ultraviolet imaging system, a laser imaging system, a SONAR imaging system, a RADAR imaging system, and a thermal imaging system), a hybrid device (e.g., a single device that includes the functionality of one or more of the above-references devices; not shown), an audio rendering device (e.g., a speaker system, a headphone system, or an earbud system; not shown), various medical devices (e.g., medical imaging equipment, heart monitoring machines, body weight scales, body temperature thermometers, and blood pressure machines; not shown), and a dedicated network device (not shown).

Users 726, 728, 730, 732 may access computer system 700 directly through network 702 or through secondary network 706. Further, computer system 700 may be connected to network 702 through secondary network 706, as illustrated with link line 734.

The various client electronic devices (e.g., client electronic devices 718, 720, 722, 724) may be directly or indirectly coupled to network 702 (or network 706). For example, personal computing device 718 is shown directly coupled to network 702 via a hardwired network connection. Further, machine vision input device 724 is shown directly coupled to network 706 via a hardwired network connection. Audio input device 722 is shown wirelessly coupled to network 702 via wireless communication channel 736 established between audio input device 720 and wireless access point (i.e., WAP) 738, which is shown directly coupled to network 702. WAP 738 may be, for example, an IEEE 802.11a, 802.11b, 802.11g, 802.11n, Wi-Fi, and/or Bluetooth™ device that is capable of establishing wireless communication channel 736 between audio input device 720 and WAP 738. Display device 722 is shown wirelessly coupled to network 702 via wireless communication channel 740 established between display device 722 and WAP 742, which is shown directly coupled to network 702.

The various client electronic devices (e.g., client electronic devices 718, 720, 722, 724) may each execute an operating system, wherein the combination of the various client electronic devices (e.g., client electronic devices 718, 720, 722, 724) and computer system 700 may form modular system 744.

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be used. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet.

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may in fact, be executed substantially concurrently, or the blocks may sometimes be executed in the reverse order, not at all, or in any combination with any other flowcharts depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
processing, using a speech processing system, an input speech signal associated with a user during a verbal communication involving the user;
determining context information for the input speech signal from an external reference associated with the verbal communication using an artificial intelligence-based prediction system;
monitoring the input speech signal for a predefined intervention pattern; and
in response to identifying the predefined intervention pattern in the input speech signal, generating one or more speech recommendations for the user based upon, at least in part, the context using the artificial intelligence-based prediction system and the speech processing system.

2. The computer-implemented method of claim 1, wherein processing the input speech signal includes processing the input speech signal in real-time.

3. The computer-implemented method of claim 1, wherein the predefined intervention pattern includes one or more of: a predefined period of silence, at least a threshold amount of inarticulate utterances within a predefined period of time, at least a threshold stress level, and at least a threshold number of mispronounced words.

4. The computer-implemented method of claim 1, wherein generating the one or more speech recommendations for the user includes generating one or more speech recommendations for the user based upon, at least in part, a user speech profile.

5. The computer-implemented method of claim 1, wherein generating the one or more speech recommendations for the user includes generating one or more synthetic speech signals including the one or more speech recommendations.

6. The computer-implemented method of claim 1, wherein generating the one or more speech recommendations for the user includes one or more of:
presenting a visual representation of the one or more speech recommendations in a user interface; and
presenting an audible representation of the one or more speech recommendations.

7. The computer-implemented method of claim 1, wherein generating the one or more speech recommendations for the user includes providing a ranked list of speech recommendations for the user to select from.

8. A computing system comprising:
a memory; and
a processor to process, using a speech processing system, an input speech signal associated with a user, to monitor the input speech signal for a predefined period of inarticulate speech, and, in response to identifying the predefined period of inarticulate speech in the input speech signal, generating one or more synthetic speech recommendations for the user using the artificial intelligence-based prediction system, a text-to-speech system, and the speech processing system.

9. The computing system of claim 8, wherein the one or more synthetic speech recommendations include one or more synthetic speech signals generated with the text-to-speech system to imitate a voice of the user.

10. The computing system of claim 8, wherein the predefined period of inarticulate speech includes one or more of: at least a threshold amount of inarticulate utterances within a predefined period of time, and at least a threshold number of mispronounced words.

11. The computing system of claim 8, wherein generating the one or more synthetic speech recommendations for the user includes generating the one or more synthetic speech recommendations for the user based upon, at least in part, a user speech profile.

12. The computing system of claim 8, wherein generating the one or more synthetic speech recommendations for the user includes defining one or more conditions for automatically providing a synthetic speech recommendation for the user.

13. The computing system of claim 8, further comprising:
generating a time window for generating the one or more synthetic speech recommendations by delaying transmission of the input speech signal by a predefined amount of time. 14, The computing system of claim 13, further comprising:
dynamically adjusting playback of the input speech signal and a synthetic speech recommendation selected by the user based upon, at least in part, the time window for generating the one or more synthetic speech recommendations.

15. A computer program product residing on a non-transitory computer readable medium having a plurality of instructions stored thereon which, when executed by a processor, cause the processor to perform operations comprising:
processing, using an automated speech recognition system, an input speech signal associated with a user;
determining presentation context information from the input speech signal using an artificial intelligence-based prediction system;
monitoring the input speech signal for a predefined intervention pattern; and
in response to identifying the predefined intervention pattern in the input speech signal, generating one or more speech recommendations for the user based upon, at least in part, the presentation context information using the artificial intelligence-based prediction system, the speech processing system, and a user speech profile, wherein the one or more speech recommendations include one or more phrases that are verbally pronounceable by the user based upon, at least in part, the user speech profile.

16. The computer program product of claim 15, wherein processing the input speech signal includes processing the input speech signal in real-time.

17. The computer program product of claim 15, wherein the predefined intervention pattern includes one or more of: a predefined period of silence, at least a threshold amount of inarticulate utterances within a predefined period of time, at least a threshold stress level, and at least a threshold number of mispronounced words.

18. The computer program product of claim 15, wherein generating the one or more speech recommendations for the user includes generating one or more synthetic speech signals including the one or more speech recommendations.

19. The computer program product of claim 15, wherein generating the one or more speech recommendations for the user includes one or more of:
presenting a visual representation of the one or more speech recommendations in a user interface; and
presenting an audible representation of the one or more speech recommendations.

20. The computer program product of claim 15, wherein generating the one or more speech recommendations for the user includes providing a ranked list of speech recommendations for the user to select from.
